(19) United States
(12) Patent Application Publication
(10) Pub. No.: US 2013/0030744 A1
(43) Pub. Date: Jan. 31, 2013

(54) MONITORING SYSTEM FOR A PACKAGING SYSTEM

(71) Applicant: Mikael Larsson, Flyinge (SE)

(72) Inventor: Mikael Larsson, Flyinge (SE)

(73) Assignee: TETRA LAVAL HOLDINGS & FINANCE S.A., Pully (CH)

(21) Appl. No.: 13/640,874

(22) PCT Filed: Apr. 8, 2011
(86) PCT No.: PCT/EP2011/055475

§ 371 Date: Oct. 12, 2012

(30) Foreign Application Priority Data
Apr. 12, 2010 (SE) 1000368-9

(51) Int. Cl. G06F 19/00; G01N 37/00

(52) U.S. Cl. 702/81

(57) ABSTRACT

A monitoring system for a packaging system comprising a plurality of machine units comprises an output sensor for measuring packages output from the packaging system, a number of pairs of machine unit sensors, each pair of sensors comprising an input sensor and an output sensor, wherein the number of pairs of machine unit sensors is arranged at a number of machine units, respectively, a processing apparatus configured to receive information from the sensors, and a communications network configured to send information from the sensors to the processing apparatus. Based on the information from the number of pairs of machine unit sensors a number of wasted packages may be determined, which in turn imply that a reliable efficiency measure may be determined.

### TECHNICAL FIELD

The invention generally relates to the field of packaging technology. More particularly, the invention relates to a monitoring system for a packaging system, a kit of parts adapted to be connected to the monitoring system, a method for determining a number of wasted packages for a machine unit, and a method for determining an efficiency measure for the packaging system.

### BACKGROUND OF THE INVENTION

Today, it is increasingly popular to pack food in carton-based packages. Apart from being cost-efficient in terms of material costs as well as transportation costs this type of packages has the advantage of being made of renewable material, which makes it a good alternative for the environment. An example of such type of package is Tetra Recart™ provided by Tetra Pak.

Packaging systems, carton-based systems as well as other, often have monitoring functionality, most often in the form of sensors for collecting information connected to a computer for processing the collected information. A measure common to determine is a so-called efficiency measure indicating the relationship between the output and the input, in other words the relationship between produced packages and input package blanks.

A number of sources of error may affect the efficiency measure. For instance, packages are from to time to time taken out of the process line by an operator for inspection, during break down packages are wasted, etc.

For companies packing products the efficiency measure is of great importance, and therefore there is a need that this measure is determined as accurately as possible.

### SUMMARY

An object is to overcome or alleviate the above-described problems. More particularly, the problem to be solved is how to achieve a monitoring system determining the efficiency measure with improved accuracy.

Further, an object is to provide a kit of parts which is easy to add to an existing monitoring system for a packaging system.

In general, when determining an efficiency measure, the inventors have realised that instead of measuring a number of input packages in the beginning of the packaging line and a number of output packages in the end of the packaging line, a more reliable efficiency measure may be determined by measuring the number of output packages and the number of wasted packages and thereby indirectly determine the number of input packages by adding the number of wasted packages with the number of output packages. Further, by determining wasted packages for a machine unit when it is empty, the incorrect contribution to the efficiency measure of the packages in the machine unit is avoided. This may be explained as below:

$$\begin{matrix}Efficiency = Output pack . / Input pack . \\ = Output pack . / ( Output pack . + Wasted pack . + \\ Packages in the packaging system ) \\ \{ if measuring waste when empty \} \\ = Output pack . / ( O utput pack . + Wasted pack )\end{matrix}$$

In order to measure the number of wasted packages, sensors are placed at one or several machine units of the packaging system.

One advantage of measuring the wasted packages instead of the input packages is that the relatively few packages affecting the efficiency measure the most are counted, which imply that a more reliable efficiency measure is achieved.

According to a first aspect a monitoring system for a packaging system comprising a plurality of machine units is provided. The monitoring system comprises a packaging system output sensor for measuring packages output from said packaging system, a number of pairs of machine unit sensors, each pair of sensors comprising a machine unit input sensor and a machine unit output sensor, wherein said number of pairs of machine unit sensors is arranged at a number of machine units, respectively, a processing apparatus configured to receive information from said packaging system output sensor and said number of pairs of machine unit sensors, and a communications network configured to send information from said packaging system output sensor and said number of pairs of machine unit sensors to said processing apparatus.

The processing apparatus may be configured to determine number of wasted packages in each of said number of machine units based on information from said number of pairs of machine unit sensors. The processing apparatus may be configured to determine when one of said number of machine units is empty based on information from said machine unit input sensor and said machine unit output sensor for said one of said number of machine units and information about speed of said one of said number of machine units.

An advantage of determining when one of said machine units is empty is that a reliable number of wasted packages may be determined based on the number of input packages and the number of output packages since no packages are left in the machine unit and thereby affecting the number of input packages, but not the number of output packages. In other words, by determining when the machine unit is empty the number of wasted packages may be determined reliably based on the number of input and output packages.

The processing apparatus may be configured to send number of wasted packages in said one of said number of machine units when said one of said number of machine units is determined to be empty.

The processing apparatus may comprise a machine unit processing device for each machine unit, and a monitoring system processing device, wherein said machine unit processing device is configured to determine number of wasted packages in said machine unit based on information from said pair of machine unit sensors, to determine when said machine unit is empty, to send number of wasted packages in said machine unit when said machine unit is determined to be empty to said monitoring system processing device, and to reset number of wasted packages in said machine unit when said machine unit is determined to be empty.

The processing apparatus may further be configured to determine an efficiency parameter by determining number of wasted packages for each of said number of machine units, determining total number of wasted packages by adding number of wasted packages for each of said number of machine units, determining total number of packages by adding a number of output packages measured by said packaging system output sensor and total number of wasted packages, and dividing said number of output packages with said total number of packages.

The number of machine units may be selected from the group consisting of package erector unit, package bottom sealing unit, package filling unit, level check unit, package top sealing unit, accumulator unit, retort unit, palletizer unit, film wrapping unit, tray loading unit, date coding unit or a combination of two or several of these.

The number of pairs of machine unit sensors may be one pair and said one pair of machine unit sensors may be arranged at an accumulator unit.

According to a second aspect a kit of parts is provided. The kit of parts comprises a machine unit input sensor arranged to detect packages fed into a machine unit, and a machine unit output sensor arranged to detect packages fed out from said machine unit, said machine unit input sensor and said machine unit output sensor forming a pair of machine unit sensors adapted to be connected to a monitoring system according to the first aspect.

The kit of parts may further comprise a machine unit processing device configured to receive information about detected packages fed into said machine unit from said machine unit input sensor and information about detected packages fed out from said machine unit from said machine unit output sensor, wherein said machine unit processing device is configured to determine number of wasted packages fed through said machine unit based on information from said machine unit input sensor and said machine unit output sensor.

The machine unit processing device may be configured to determine when said machine unit is empty based on information from said machine unit input sensor, said machine unit output sensor and information about the speed of said machine unit.

The machine unit processing device may be configured to determine and send information about number of wasted packages in said machine unit when said machine unit is determined to be empty.

According to a third aspect a method for determining a number of wasted packages for a machine unit is provided. The method comprises determining a number of packages fed into said machine unit based on information about detected packages from a machine unit input sensor, determining a number of packages fed out from said machine unit based on information about detected packages from a machine output sensor, and determining said number of wasted packages based on said number of packages fed into said machine unit and said number of packages fed out from said machine unit.

The method may further comprise determining if said machine unit is empty based on information from said machine input sensor and said machine output sensor, and information about the speed of said machine unit, and then determining said number of wasted packages.

According to a fourth aspect a method for determining an efficiency measure for a packaging system comprising a plurality of machine units, said method comprising determining number of wasted packages for each of a number of machine units of said plurality of machine units according to the third aspect, determining total number of wasted packages by adding said number of wasted packages for each of said number of machine units, determining total number of packages by adding a number of output packages based on information from a packaging system output sensor and said total number of wasted packages, and dividing said number of output packages with said total number of packages.

According to a fifth aspect a computer program is provided. The computer program comprising computer program code adapted to perform the steps according to any one of the third or fourth aspect when said program code is executed on a computer.

As described above, a number of the plurality of machine units may be provided with sensors. This should be understood as that some or all of the machine units may be provided with sensors. For instance, the machine units generating a lot of waste or holding many packages may be provided sensors.

The wording processing apparatus should be interpreted broadly. It can be one single piece of hardware or a distributed system comprising a number of pieces of hardware. More particularly, the processing apparatus may comprise a machine unit processing device for one or several machine units and a monitoring system processing device connected to the machine unit processing devices.

Further, the processing apparatus, or the machine unit processing devices, can be configured to interpret the output from the sensors, e.g. determine if a package is present or not based on a signal, or alternatively the sensors themselves may comprise functionality for interpreting the signal.

The wording communications network should also be interpreted broadly. Information may be sent via wire or wireless via e.g. Wi-Fi, UMTS. Further, the information may be sent direct from, for instance, the machine units to the monitoring system processing device, or indirect via other computers.

Further, several monitoring system processing devices may exist. For instance, one monitoring system processing device may be placed on site and another monitoring system processing device may be placed at the service provider, thereby making it possible for the service provider to remotely support the packaging system. Additionally, if having several monitoring system processing devices, these may be arranged such that wasted packages, efficiency measure etc are determined in one of the monitoring processing system devices and then distributed to the other.

### BRIEF DESCRIPTION OF THE DRAWINGS

The above, as well as additional objects, features and advantages of the present invention, will be better understood through the following illustrative and non-limiting detailed description of preferred embodiments of the present invention, with reference to the appended drawings, wherein:

FIG. 1 illustrates a general overview of a packaging system.

FIG. 2 illustrates in further detail an accumulator unit of the packaging system illustrated in FIG. 1.

FIG. 3 is a flowchart illustrating a method for determining an efficiency measure for a packaging system.

### DETAILED DESCRIPTION OF PREFERRED EMBODIMENTS

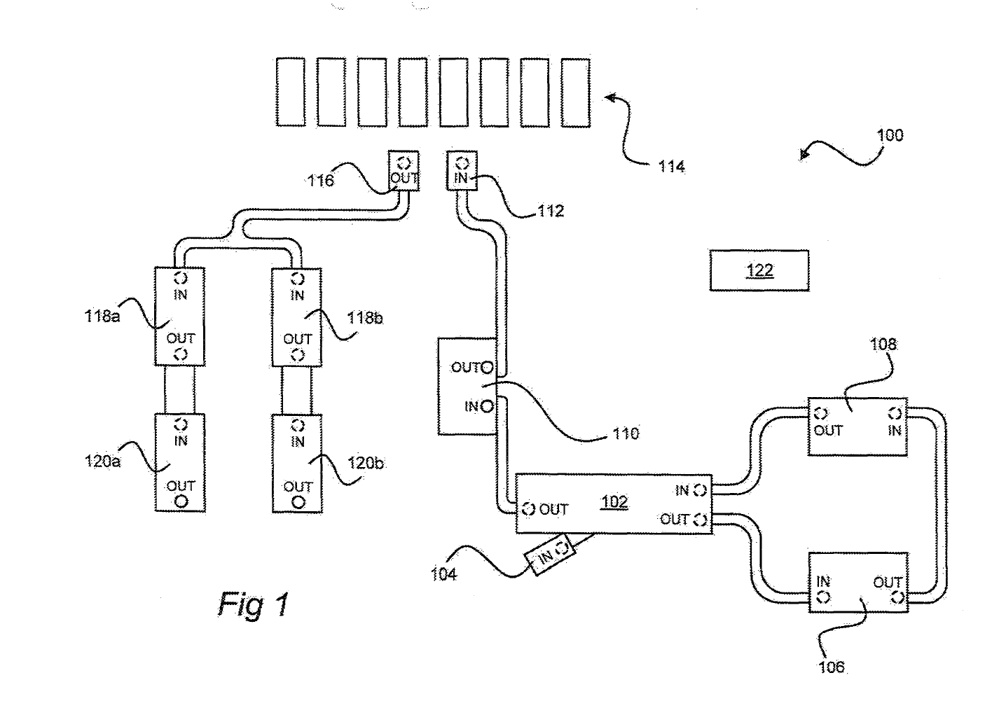

FIG. 1 illustrates an example of a carton-based packaging system 100 for food comprising a plurality of machine units provided with sensors, such as photocells, for detecting packages input and packages output. In this example the sensors are divided into default sensors, i.e. sensors required in this example, depicted with solid line circles, and optional sensors, herein depicted with dashed line circles.

The process line starts with a forming and sealing unit 102. Packages, in the form of blanks with pre-made longitudinal sealings, are fed from an infeed 104. After being fed into the forming and sealing unit 102 the packages are erected into sleeves. In order to keep track of packages fed into the forming and sealing unit 102, the infeed 104 may optionally be provided with a machine input sensor. After having erected the packages, bottoms are formed and sealed. The packages leave the forming and sealing 102 with an open top end. In order to detect a number of packages output from the forming and sealing unit 102 an output sensor may optionally be placed at an outfeed.

Via a conveyor, the packages are transported into a filling unit 106 arranged to fill the packages with food via the open top end. In order to determine the number of packages wasted in this machine unit an input sensor and an output sensor may be used. One reason for wasting a package in the filling unit may be that packages are overfilled.

After having been filled with food product the packages can optionally be conveyed to a level check unit 108. The level check unit 108 may be provided with an input sensor and an output sensor in order to determine a number of wasted packages in the machine unit. One reason for wasting packages in the level check unit may be because the filling level of the packages is incorrect, thereby making it hard, or even impossible, to make adequate top sealings.

Next step, in this particular example, the packages are conveyed into the forming and sealing unit 102 once again. This time the open ends of the packages are sealed and top portions of the packages are formed, e.g. by folding down the sealing end in order to form a flat top and to fold down the outer flaps of the sealing end towards the side sections of the packages. In this way brick shaped packages are formed. As illustrated, an input sensor may be placed at the input as well as the output of the forming and sealing unit 102 in order to measure a number of wasted packages during top sealing and top forming. One reason for wasting packages during these procedures may be because of insufficient top sealing.

The sealed and formed packages can thereafter be conveyed to an accumulator unit 110. The reason for having the accumumlator unit 110 is to store packages. In other words, when having the accumulator unit 110, the forming and sealing unit 102, the filling unit 104 and the level check unit 106 may continue to run even if a breakdown has occurred downstreams in the packaging line, since the packages may be stored in the accumulator unit 110. As the other machine units, the accumulator unit 110 may be provided with an input sensor and an output sensor. One reason for wasting packages in the accumulator unit 110 can be that when the accumulator unit 110 is full packages are wasted. In this example only one accumulator unit 110 is present, but in order to make it possible to store more packages several accumulator units placed after each other may be used.

Next, the packages are conveyed to a handling system input station 112. In this station a number of packages are loaded onto racks. The racks are in a next step placed in a retorting device 114 for being retorted. By retorting the packages and the content of the packages the due date may be extended to 24 months. After having been retorted the packages are put into the packaging line again via a handling system output station 116.

The handling system may be automatic, manual or semi-automatic, that is, having some of the steps being performed automatically, such as loading the trays, and some of the steps being performed manually, such as loading the trays into the retorting devices.

The handling system input station 112 may be provided with an input sensor and the handling system output station 116 may be provided with an output sensor. In this way, the number of wasted packages in the handling system may be measured.

Next, in this example, the packages are conveyed to secondary packaging units 118a, 118b. In this example, the system is designed such that the line of packages are divided into two parallel packaging lines, thereby making it possible to use two secondary packaging units 118a, 118b simultaneously.

The secondary packaging units 118a, 118b can be arranged to gather a number of packages and to place these in a secondary package, such as a carton board tray. Input sensors and an output sensors may be used to determine a number of wasted packages in these units.

As the last step of this packaging system, the secondary packages can be conveyed to film wrapping units 120a, 120b. In these units, the secondary packages from the secondary packaging units 118a, 118b are wrapped in plastic film. Input sensors and an output sensors may be used to determine a number of wasted secondary packages in these units, and thereby implicitly the number of packages wasted since the number of packages per secondary package is known.

Although not illustrated, the secondary packages wrapped in plastic film may be conveyed to a palletizer which load the secondary packages onto a pallet. Also in this unit an input sensor and an output sensor may be used to determine the number of wasted secondary packages.

As illustrated, in this example, the input sensor and output sensor for an accumulator unit 110 and the output sensors from two parallel film wrappers 120a, 120b are set as default. The accumulator unit 110 is chosen as default because packages may be wasted in the accumulator unit if the accumulator unit is full, which may arise when breakdown has occurred after the accumulator and the process line before the accumulator unit 110 is still running. Thus, since it is likely that packages is wasted in the accumulator unit 110 the input and output sensor of the accumulator unit 110 have been set as default.

Moreover, a good reason to set the input sensor and the output sensor of the accumulator unit 110 as default is that a large number of packages may be held within the accumulator unit 110, thereby affecting the efficiency measure significantly if only measuring input packages to the packaging system and output packages from the packaging system. If however measuring packages input to the accumulator unit 110 and packages output from the accumulator unit 110, and determining wasted packages when the accumulator unit is empty a more reliable efficiency measure is obtained.

The output sensors of the film wrapping units 120a, 120b can be set as default since these represent the output from the packaging system. Thus, by having a pair of machine unit sensors placed at the accumulator unit 110 and output sensors placed at the last machine unit or machine units of the packaging system, in this example the film wrapping machine units 120a, 120b, the main part of the number of wasted packages will be determined, since the main part of the packages are wasted in the accumulator unit 110, as well as the output from the packaging system 100 as a whole. Based on the number of wasted packages and the number of output packages an efficiency measure may be determine by dividing the number of output packages with the total number of packages, which is determined by adding the number of output packages with the total number of wasted packages.

Where to place the machine unit sensors depend on the design of the packaging system. In this particular example, the accumulator unit is chosen since packages are wasted in this machine unit and moreover because a large number of packages may be held within the accumulator unit 110.

However, in other packaging systems other machine units may be of more interest to monitor. For instance, a packaging system may comprise a quality check machine unit arranged to check the packages and waste the packages not fulfilling preset standards. In such a case, machine unit sensors are preferably placed at this quality check machine unit since a number of packages are wasted in this machine unit.

The information about detected packages by the input sensors and the output sensors may be sent to a processing apparatus 122, such as a computer comprising a processor, a memory and a receiver for receiving the information from the sensors. The processing apparatus 122 may be configured to determine the efficiency measure as described above and to forward this to e.g. an operator panel.

The information about detected packages may be sent by wire or wireless using any present standard for sending information, such as UMTS and WiFi (IEEE 802.11).

Alternatively, instead of sending information from the sensor directly to the processing device, a machine unit processing device connected to the input sensor and the output sensor may be used to determine the number of wasted packages based on the information from the sensors. The information from the machine unit processing device may be sent to a packaging system processing device configured to collect information about wasted packages from the machine unit processing devices and the packaging system output sensors and based on this information determine and distribute the efficiency measure.

In order to make sure that reliable information is sent about wasted packages, the machine unit processing device may be configured to send information to the monitoring system processing device when the machine unit is empty. In this way, the risk of counting the packages within the machine unit as wasted is eliminated. As described above, the machine unit processing device may determine when the machine is empty based on the information from the input sensor and the output sensor since the speed of the machine unit is known. If the speed varies, the speed may be input to the machine unit processing device.

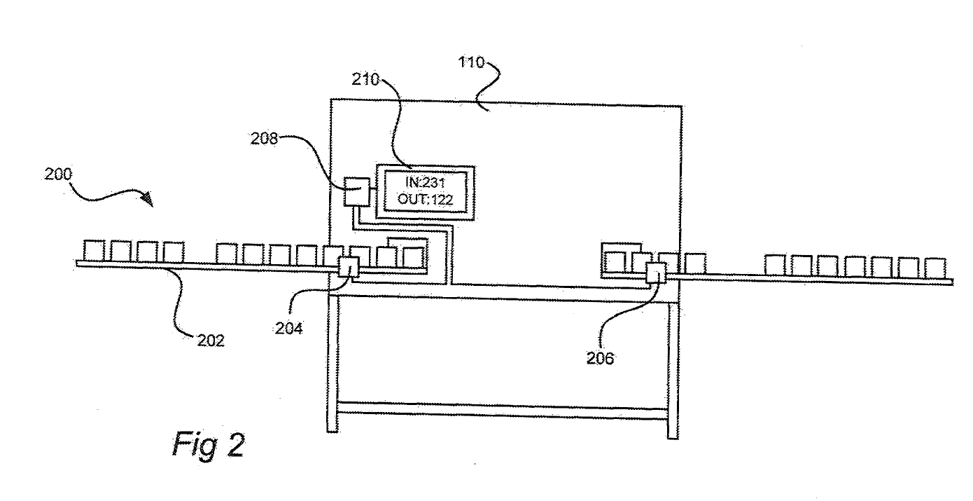

FIG. 2 illustrates a side view of the accumulator unit 110 in greater detail. Packages 200 are fed via a conveyor 202 into the accumulator unit 110. Before entering the accumulator unit 110 an input sensor 204 is detecting the number of packages. The input sensor 204 may as in this example be placed next to the conveyor 202. In order to determine a number of output packages an output sensor 206 can be placed at the outfeed of the accumulator unit 110.

In this example, the input sensor 204 and the output sensor 206 send information to a machine unit processing device 208. The machine unit processing device can be configured to determine the number of input packages based on the information from the input sensor 204 and the number of output packages based on the information from the output sensor 206. Further, since the machine unit speed is known, the machine unit processing device 208 may determine if the accumulator unit 110 is empty or not. If the accumulator unit is empty, the number of wasted packages can be determined based on the number of input packages and the number of output packages and sent to a monitoring system processing device.

The communication between the input sensor 204 and the machine unit processing device 208, and the communication between the output sensor 206 and the machine unit processing device 208 may be via wire, as illustrated, or alternatively via wireless communication. The machine unit processing device 208 may be connected to a display 210 presenting the number of input and output packages.

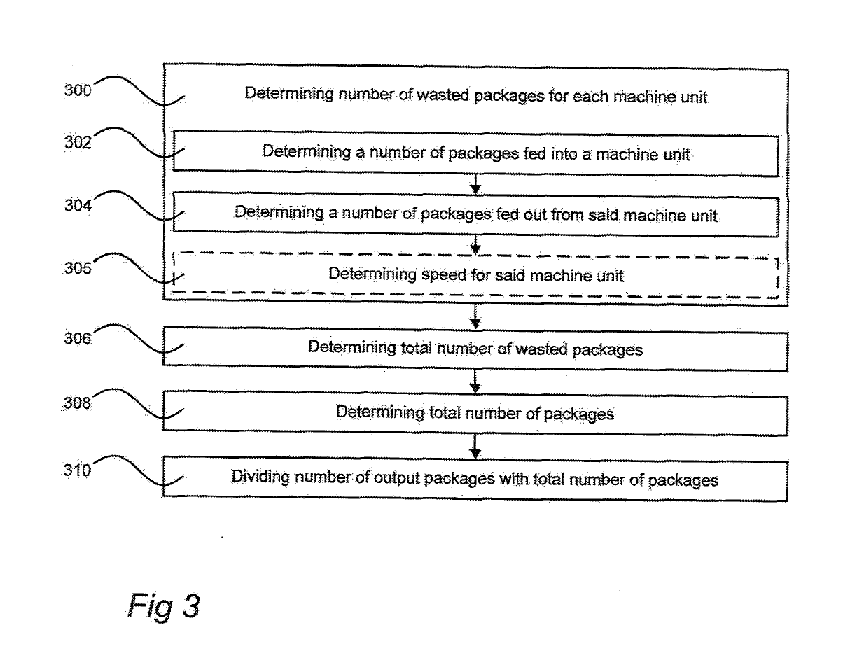

FIG. 3 illustrates a flow chart presenting a method for determining an efficiency measure for a packaging system.

In a first step a number of wasted packages for each machine unit of a number of machine units in the packaging system is determined 300. This step may in turn comprise two sub-steps, namely determining a number of packages fed into said machine unit 302 and determining a number of packages fed out from said machine unit 304. In order to know when to collect this information and/or send this information a step for determining if the machine unit is empty or not may be added 305. When determining if the machine unit is empty or not the speed of the machine unit may be taken into account. These steps may be performed in each machine unit by a machine unit processing device.

In a next step the total number of wasted packages is determined 306. This may be determined by a monitoring system processing device configured to collect information from the machine unit processing devices.

Next, a total number of output packages are determined, e.g. by collecting information from the output sensors placed in the end of the packaging line, possibly via a machine unit processing device. Since this step is not dependent of the number of wasted packages this step may be performed independently of the steps for determining the number of wasted packages. For instance, the number of output packages may be determined continuously.

When having the number of output packages and the number of wasted packages the total number of packages may be determined 308 by adding these two together.

Finally, in order to get the efficiency measure the number of output packages is divided by the total number of packages 310.

Moreover, it should be understood that what is herein referred to as an input sensor may also be used as an output sensor, and vice versa. Thus, by using the input sensors as output sensors and the output sensors as input sensors a number of wasted packages between the machine units may also be determined.

The invention has mainly been described above with reference to a few embodiments. However, as is readily appreciated by a person skilled in the art, other embodiments than the ones disclosed above are equally possible within the scope of the invention, as defined by the appended patent claims.

1. A monitoring system for a packaging system comprising a plurality of machine units, said monitoring system comprising
a packaging system output sensor for measuring packages output from said packaging system,
a number of pairs of machine unit sensors, each pair of sensors comprising a machine unit input sensor and a machine unit output sensor,
wherein said number of pairs of machine unit sensors is arranged at a number of machine units, respectively,
a processing apparatus configured to receive information from said packaging system output sensor and said number of pairs of machine unit sensors, and
a communications network configured to send information from said packaging system output sensor and said number of pairs of machine unit sensors to said processing apparatus.

2. The monitoring system according to claim 1, wherein said processing apparatus is configured to determine number of wasted packages in each of said number of machine units based on information from said number of pairs of machine unit sensors.

3. The monitoring system according to claim 2, wherein said processing apparatus is configured to determine when one of said number of machine units is empty based on information from said machine unit input sensor and said machine unit output sensor for said one of said number of machine units and information about speed of said one of said number of machine units.

4. The monitoring system according to claim 3, wherein said processing apparatus is configured to send number of wasted packages in said one of said number of machine units when said one of said number of machine units is determined to be empty.

5. The monitoring system according to claim 4, wherein said processing apparatus comprises
a machine unit processing device for each machine unit, and
a monitoring system processing device,
wherein said machine unit processing device is configured to determine number of wasted packages in said machine unit based on information from said pair of machine unit sensors, to determine when said machine unit is empty, to send number of wasted packages in said machine unit when said machine unit is determined to be empty to said monitoring system processing device, and to reset number of wasted packages in said machine unit when said machine unit is determined to be empty.

6. The monitoring system according to claim 1, wherein said processing apparatus is further configured to determine an efficiency parameter by determining number of wasted packages for each of said number of machine units,
determining total number of wasted packages by adding number of wasted packages for each of said number of machine units,
determining total number of packages by adding a number of output packages measured by said packaging system output sensor and total number of wasted packages, and
dividing said number of output packages with said total number of packages.

7. The monitoring system according to claim 1, wherein said number of machine units is selected from the group consisting of package erector unit, package bottom sealing unit, package filling unit, level check unit, package top sealing unit, accumulator unit, retort unit, palletizer unit, film wrapping unit, tray loading unit, date coding unit or a combination of two or several of these.

8. The monitoring system according to claim 1, wherein said number of pairs of machine unit sensors is one pair and said one pair of machine unit sensors is arranged at an accumulator unit.

9. A kit of parts comprising,
a machine unit input sensor arranged to detect packages fed into a machine unit, and
a machine unit output sensor arranged to detect packages fed out from said machine unit,
said machine unit input sensor and said machine unit output sensor forming a pair of machine unit sensors adapted to be connected to a monitoring system according to claim 1.

10. The kit of parts according to claim 9, further comprising
a machine unit processing device configured to receive information about detected packages fed into said machine unit from said machine unit input sensor and information about detected packages fed out from said machine unit from said machine unit output sensor,
wherein said machine unit processing device is configured to determine number of wasted packages fed through said machine unit based on information from said machine unit input sensor and said machine unit output sensor.

11. The kit of parts according to claim 10, wherein said machine unit processing device is configured to determine when said machine unit is empty based on information from said machine unit input sensor, said machine unit output sensor and information about the speed of said machine unit.

12. The kit of parts according to claim 11, wherein said machine unit processing device is configured to determine and send information about number of wasted packages in said machine unit when said machine unit is determined to be empty.

13. A method for determining a number of wasted packages for a machine unit, said method comprising
determining a number of packages fed into said machine unit based on information about detected packages from a machine unit input sensor,
determining a number of packages fed out from said machine unit based on information about detected packages from a machine output sensor, and
determining said number of wasted packages based on said number of packages fed into said machine unit and said number of packages fed out from said machine unit.

14. The method according to claim 13, said method further comprising
determining if said machine unit is empty based on information from said machine input sensor and said machine output sensor, and information about the speed of said machine unit, and then determining said number of wasted packages.

15. A method for determining an efficiency measure for a packaging system comprising a plurality of machine units, said method comprising
determining number of wasted packages for each of a number of machine units of said plurality of machine units according to claim 13,
determining total number of wasted packages by adding said number of wasted packages for each of said number of machine units,
determining total number of packages by adding a number of output packages based on information from a packaging system output sensor and said total number of wasted packages, and
dividing said number of output packages with said total number of packages.

16. A computer program comprising computer program code adapted to perform the steps according to claim 13 when said program code is executed on a computer.
